(19) United States
(12) Patent Application Publication
(10) Pub. No.: US 2008/0107013 A1
(43) Pub. Date: May 8, 2008

(54) SIGNATURE GENERATION USING CODED WAVEFORMS

(75) Inventors: Adrian Boariu, Irving, TX (US); Tony Reid, Plano, TX (US)

Correspondence Address: BRAKE HUGHES BELLERMANN LLP, c/o INTELLEVATE, P.O. BOX 52050, MINNEAPOLIS, MN, 55402, US

(73) Assignee: Nokia Corporation, Espoo (FI)

(21) Appl. No.: 11/933,612

(22) Filed: Nov. 1, 2007

Related U.S. Application Data
(60) Provisional application No. 60/864,578, filed on Nov. 6, 2006.

(51) Int. Cl. H04B 7/14; H04J 7/00

(52) U.S. Cl. 370/213; 375/211; 370/315; 370/338

(57) ABSTRACT

Various example embodiments are disclosed relating to wireless networks such as relay networks or multi-hop networks, and also relating to transmitting a signal using coding schemes and multiple frequencies. According to an example embodiment, a different wireless signature may be assigned to one or more nodes in a wireless network, each wireless signature indicating an energy transmission on a set of tones, each wireless signature being substantially orthogonal with or distinguishable from one or more other wireless signatures. A wireless signature may be received, and a transmitting wireless node may be determined based on the wireless signature.

### CROSS-REFERENCE TO RELATED APPLICATION

This application claims priority based on U.S. Provisional Application No. 60/864,578, filed on Nov. 6, 2006, entitled, “Signature Generation Using Coded Waveforms,” the disclosure of which is hereby incorporated by reference.

### BACKGROUND

The rapid diffusion of Wireless Local Area Network (WLAN) access and the increasing demand for WLAN coverage is driving the installation of a very large number of Access Points (AP). The most common WLAN technology is described in the Institute of Electrical and Electronics Engineers IEEE 802.11 family of industry specifications, such as specifications for IEEE 802.11b, IEEE 802.11g and IEEE 802.11a. Other wireless technologies are being developed, such as IEEE 802.16 or WiMAX technology. A number of different 802.11 task groups are involved in developing specifications relating to improvements to the existing 802.11 technology. For example, a draft specification from the IEEE 802.11e Task Group has proposed a set of QoS parameters to be used for traffic between an Access Point and a station. See, e.g., Tim Godfrey, “Inside 802.11e: Making QoS A Reality Over WLAN Connections,” CommsDesign, Dec. 19, 2003. Similarly in an Ultra Wideband (UWB) environment, the WiMedia Alliance has published a draft standard, “Distributed Medium Access Control (MAC) for Wireless Networks,” Release 1.0, Dec. 8, 2005.

As another example, a wireless relay network may include a multi-hop system in which end nodes such as mobile stations or subscriber stations (MS/SSs) may be coupled to a base station (BS) or Access Point (AP) via one or more relay stations (RSs). Thus, traffic between MS/SSs and the BS/AP may pass and be processed by the relay stations. The 802.16 Mobile Multi-hop Relay (MMR), referenced in IEEE 802.16 WG, is an example of a set of specifications relating to the relay concept. The MMR specifications include a focus on defining a network system that uses relay stations (RSs) to extend network coverage and/or enhance system throughput. These are a few examples of wireless network specifications, and there are many other technologies and standards being developed.

In communication systems there are numerous techniques for transmitting signals, and such techniques may, for example, be generally categorized as employing coherent or non-coherent modulations. Techniques employing coherent modulations may take advantage of the knowledge of the channel at the receiver in order to convey a specific message (e.g., information). Coherent modulations may be preferred in current communication systems because they may offer higher throughput, i.e., higher system capacity. However, non-coherent modulation techniques may offer an advantage in that it may not be necessary to have knowledge of the channel at the receiver, i.e., the non-coherent techniques may be simpler than coherent modulation techniques.

Frequency division multiplexing (FDM) is a technique for transmitting multiple signals simultaneously over a single transmission path, for example, a cable or wireless system. Each signal may travel within its own unique frequency range (i.e., carrier), which may be modulated by the data (e.g., text, voice, video, etc.). Orthogonal FDM (OF DM) spread spectrum techniques may distribute the data over a large number of carriers that may be spaced apart at precise frequencies. This spacing thus provides the “orthogonality” in this technique which may aid in preventing demodulators from seeing frequencies other than their own. Some example benefits of OFDM may include high spectral efficiency, resiliency to radio frequency (RF) interference, and lower multi-path distortion. Such features may be useful, for example, in a terrestrial broadcasting scenario where there may be multipath-channels (e.g., a transmitted signal may arrive at a receiver using various paths of different lengths). Since multiple versions of the signal may interfere with each other (e.g., due to inter-symbol interference (ISI)) it may become difficult to extract the original information. A discussion of example coding techniques is included in F. J. MacWilliams and N. J. A. Sloane, A theory of error correcting codes, Elsevier, 1998.

In addition, various carrier sensing techniques are sometimes employed in wireless networks and may indicate that a wireless channel is occupied by a user, but typically do not identify the user. Solutions are desirable that allow identification of resources, for example, wireless nodes, relay stations and other network resources for wireless networks, multi-hop or relay networks, or other networks.

### SUMMARY

Various example embodiments are disclosed relating to relay networks or multi-hop networks, and also relating to transmitting a signal using coding schemes and multiple frequencies. A relay network may include, for example, a base station, a mobile station/subscriber station, and one or more relay stations that may couple a mobile station to a base station.

According to an example embodiment, a method of identifying wireless nodes in a relay network may include assigning a first wireless signature identifier to a first wireless node, and instructing the first wireless node to transmit a first wireless signature based on on-off keying modulation and a non-binary code having at least a predetermined threshold of separability, based on the first wireless signature identifier.

According to an example embodiment, the first wireless signature may be generated by the first wireless node based on an (N, K) Reed-Solomon code. For example, the first wireless node may generate the first wireless signature based on a multitone M-level on-off keying (MTM-OOK) type of waveform.

According to an example embodiment, the first wireless signature may be generated based on a multitone on-off keying (MTOOK) type of waveform.

According to an example embodiment, the first wireless signature may be generated based on a multitone on-off keying (MTOOK) type of waveform based on a Hadamard code.

According to an example embodiment, the first wireless signature may be generated based on a multi-level (N, K) Reed-Solomon code, wherein a set of codewords having no collisions is generated based on a codeword represented as an N-tuple having a value of 1 in each position of the N-tuple.

According to an example embodiment, the first wireless signature may be generated based a multi-level (N, K) Reed-Solomon code, wherein a set of codewords having no collisions is generated based on recursive generation of the codewords, based at least in part on a codeword represented as an N-tuple having a value of 1 in each position of the N-tuple.

According to another example embodiment a method may include receiving from a base station an indicator of a first wireless signature based on on-off keying modulation and a non-binary code having at least a predetermined threshold of separability. The method may further include determining whether the first wireless signature is received from a first wireless node, and sending to the base station an indication of receipt of the first wireless signature from the first wireless node.

According to another example embodiment, an apparatus for wireless communications may be provided. The apparatus may include a controller, a memory coupled to the controller, and a wireless transceiver coupled to the controller. The apparatus may be adapted to: assign a first wireless signature identifier to a first wireless node, and instruct the first wireless node to transmit a first wireless signature based on transmitting energy based on on-off keying modulation and a non-binary code having a predetermined threshold of separability, based on the first wireless signature identifier.

According to another example embodiment, an apparatus for wireless communications may be provided. The apparatus may include: a controller, a memory coupled to the controller, and a wireless transceiver coupled to the controller. The apparatus may be adapted to: receive from a base station an indicator of a first wireless signature based on on-off keying modulation and a non-binary code having a predetermined threshold of separability, determine whether the first wireless signature is received from a first wireless node, and send to the base station an indication of receipt of the first wireless signature from the first wireless node.

According to yet another example embodiment, a different wireless signature may be assigned to one or more nodes in a wireless network, each wireless signature indicating an energy transmission on a set of tones, each wireless signature being substantially orthogonal with or distinguishable from one or more other wireless signatures. A wireless signature may be received, and a transmitting wireless node may be determined based on the wireless signature.

The details of one or more implementations are set forth in the accompanying drawings and the description below. Other features will be apparent from the description and drawings.

### BRIEF DESCRIPTION OF THE DRAWINGS

FIG. 1 is a block diagram illustrating a wireless network according to an example embodiment.

FIG. 2 is a block diagram illustrating a wireless network according to an example embodiment.

FIG. 3a is a block diagram illustrating a wireless relay network according to an example embodiment.

FIG. 3b is a diagram of a multi-hop environment according to an example embodiment.

FIG. 3c is a block diagram illustrating a wireless relay network according to an example embodiment.

FIG. 4 is a block diagram illustrating an example system for generating a wireless signature according to example embodiments.

FIG. 5 is a diagram illustrating an example frequency axis having evenly-spaced tones and unevenly-spaced tones according to an example embodiment.

FIG. 6 is a flow chart illustrating operation at a wireless node according to an example embodiment.

FIG. 7 is a flow chart illustrating operation at a wireless node according to another example embodiment.

FIG. 8 is a flow chart illustrating operation at a wireless node according to another example embodiment.

FIG. 9 is a block diagram illustrating an apparatus that may be provided in a wireless node according to an example embodiment.

### DETAILED DESCRIPTION

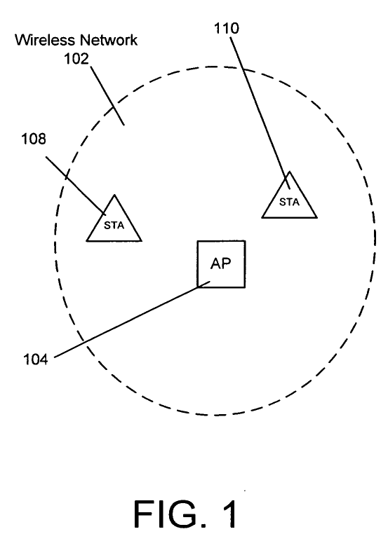

Referring to the Figures in which like numerals indicate like elements, FIG. 1 is a block diagram illustrating a wireless network 102 according to an example embodiment. Wireless network 102 may include a number of wireless nodes or stations, such as an access point (AP) 104 or base station and one or more mobile stations or subscriber stations, such as stations 108 and 110. While only one AP and two mobile stations are shown in wireless network 102, any number of APs and stations may be provided. Each station in network 102 (e.g., stations 108, 110) may be in wireless communication with the AP 104, and may even be in direct communication with each other. Although not shown, AP 104 may be coupled to a fixed network, such as a Local Area Network (LAN), Wide Area Network (WAN), the Internet, etc., and may also be coupled to other wireless networks.

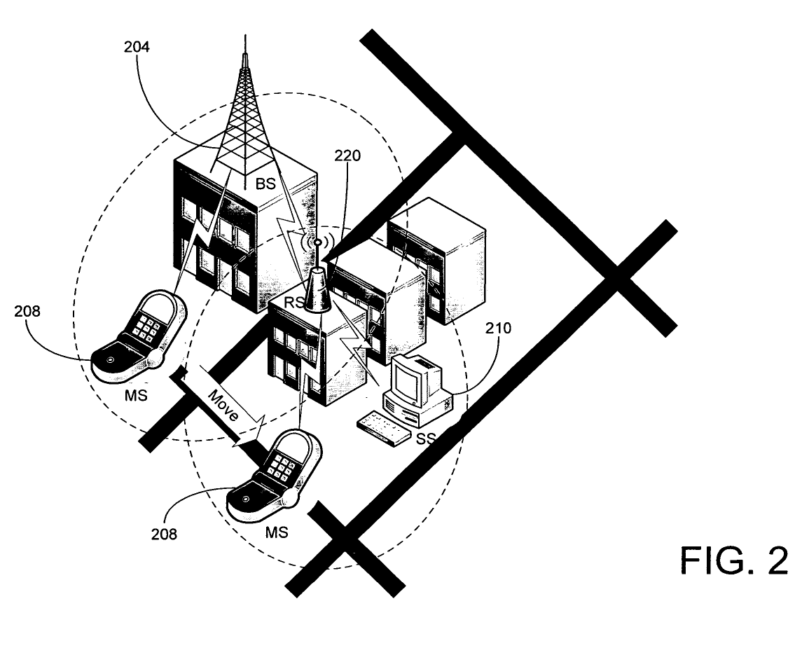

FIG. 2 is a block diagram illustrating a wireless network according to an example embodiment. According to an example embodiment, a mobile station MS 208 may initially communicate directly with a base station BS 204, for example, and a subscriber station 210 may communicate with the base station BS 204 via a relay station RS 220. In an example embodiment, the mobile station 208 may travel or move with respect to base station BS 204. For example, the mobile station MS 208 may move out of range of the base station BS 204, and may thus begin communicating with the base station 204 via the relay station 220 as shown in FIG. 2.

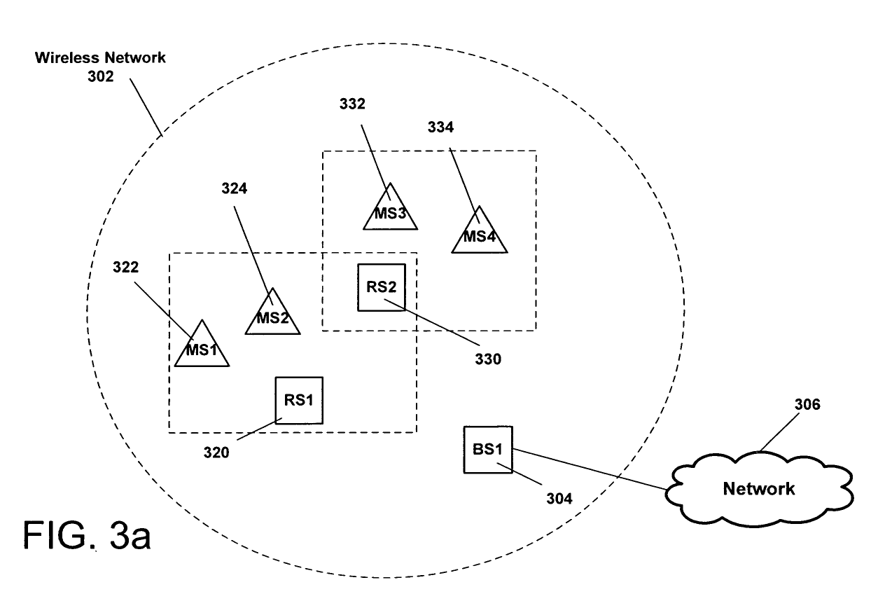

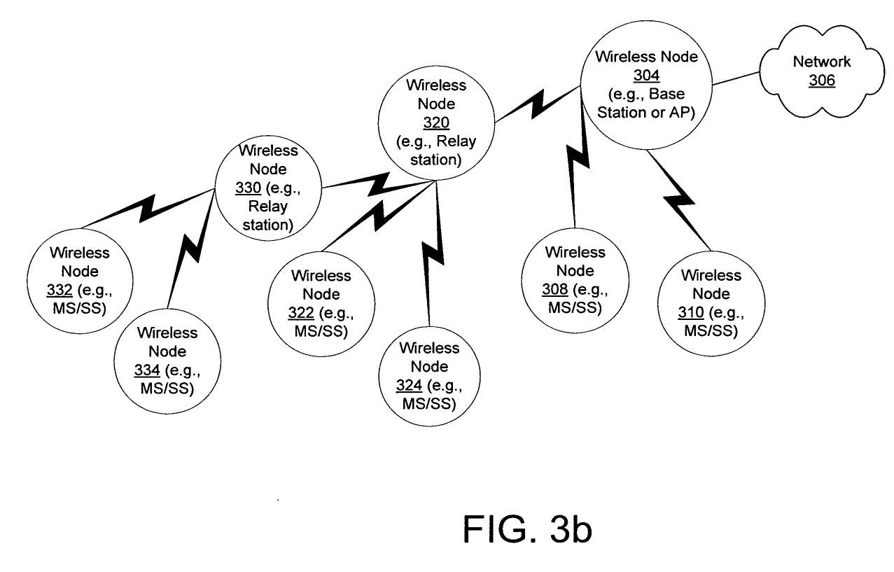

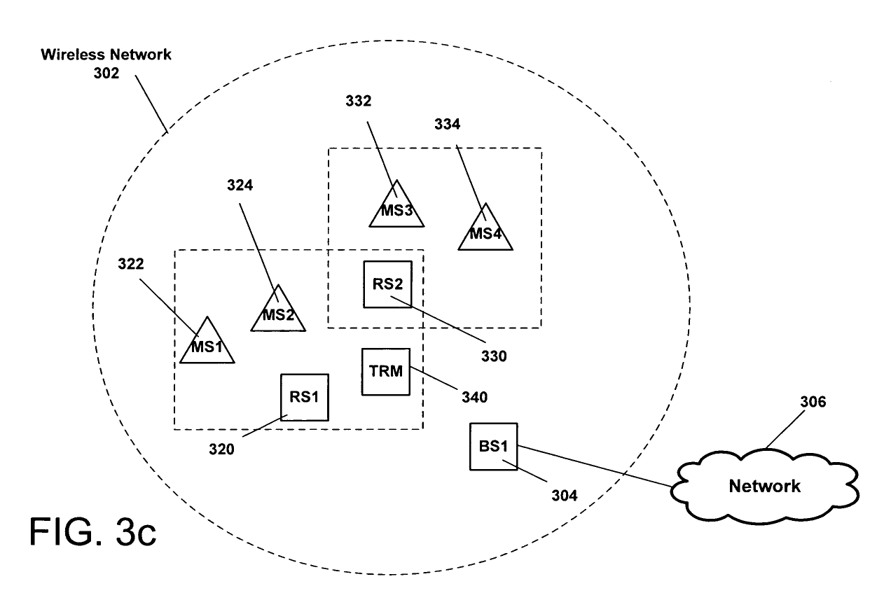

FIG. 3a is a block diagram illustrating a wireless network 302 according to an example embodiment. Wireless network 302 may include a number of wireless nodes or stations, such as base station BS1 304, relay stations RS1 320 and RS2 330, a group of mobile stations, such as MS 1322 and MS2 324 communicating with relay station RS1 320, and MS3 332 and MS4 334 communicating with relay station RS2 330. As shown, relay station RS2 330 also communicates with relay station RS1 320. While only one base station, two relay stations, and four mobile stations are shown in wireless network 302, any number of base stations, relay stations, and mobile stations may be provided. The base station 304 may be coupled to a fixed network 306, such as a Wide Area Network (WAN), the Internet, etc., and may also be coupled to other wireless networks. The group of stations MS1 322, MS2 324, and RS2 330 may communicate with the base station BS1 304 via the relay station RS1 320. The group of stations MS3 332, MS4 334, may communicate with the base station BS1 304 via the relay station RS2 330, which communicates with the base station BS1 304 via the relay station RS1 320.

FIG. 3b is a diagram of a multi-hop environment according to an example embodiment. A group of wireless nodes 332, 334, which may be mobile stations or subscriber stations (MS/SS), may each be coupled via a wireless link to a wireless node 330. As an example, the wireless nodes 332, 334 may include mobile telephones, wireless digital assistants (PDAs), or other types of wireless access devices, or mobile stations. The term “node” or “wireless node” or “network node” or “network station” may refer, for example, to a wireless station, e.g., a subscriber station or mobile station, an access point or base station, a relay station or other intermediate wireless node, or other wireless computing device, as examples. Wireless node 330 may include, for example, a relay station or other node. Wireless node 330 and other wireless nodes 322, 324 may each be coupled to a wireless node 320 via a wireless link. Wireless node 320 and other wireless nodes 308, 310 may each may be coupled to a wireless node 304 via a wireless link. Wireless node 304 may be, for example, a base station (BS), access point (AP) or other wireless node. Wireless node 304 may be coupled to a fixed network, such as network 306, for example. Frames or data flowing from nodes 332, 334 to 330, 322 324, and 330 to 320, and 308, 310, 320 to node 304 may be referred to as flowing in the uplink (UL) or upstream direction, whereas frames flowing from node 304 to nodes 308, 310, and to node 320 and then to nodes 330, 322, 324, 332, and 334 may be referred to as flowing in the downlink (DL) or downstream direction, for example.

In communication systems, signals may be transmitted, for example, based on coherent and non-coherent modulation techniques. Coherent modulation techniques may take advantage of the knowledge of the channel at the receiver in order to convey a specific message (e.g., information). These types of modulation techniques may be preferred in communication systems because they may offer higher throughput, i.e., higher system capacity. However, non-coherent modulation techniques may offer an advantage in that it may not be necessary to have knowledge of the channel at the receiver, i.e., they are much simpler. The following discussion is related to non-coherent modulation techniques. For example, a set of frequencies may be assigned to a message that are used to convey the message (e.g., a wireless signature) over the channel. Transmitting more frequency tones may provide more resilience to fading, while combining this with coding may provide a large set of wireless signatures that have good distance properties.

The various example embodiments described herein may be applicable to a wide variety of networks and technologies, such as WLAN networks (e.g., IEEE 802.11 type networks), IEEE 802.16 WiMAX networks, relay networks, 802.16 Mobile Multi-hop Relay (MMR) networks, as referenced in IEEE 802.16 WG, WiMedia networks, Ultra Wide Band networks, cellular networks, radio networks, or other wireless networks. In another example embodiments the various examples and embodiments may be applied, for example, to a mesh wireless network, where a plurality of mesh points (e.g., Access Points) may be coupled together via wired or wireless links. The various example embodiments described herein may be applied to wireless networks, both in an infrastructure mode where an AP or base station may communicate with a station (e.g., communication occurs through APs), as well as an ad-hoc mode in which wireless stations may communicate directly via a peer-to-peer network, for example.

A wireless relay network may be an example of a multi-hop system in which end nodes, for example, mobile stations or subscriber stations (MS/SS), may be connected to a base station via one or more relay stations, such as RS1 320 and RS2 330, for example. Traffic between the mobile stations or subscriber stations and the base station may pass through, and be processed by, the relay stations RS1 320 and RS2 330, for example. As an example, a relay station may be used to extend the network coverage and/or enhance the system throughput. For example, the traffic sent from a relay station may be scheduled by the relay station itself or scheduled by the base station instead. In some cases, a relay station may receive and decode a frame from a base station, and then forward the frame to the respective mobile station or subscriber station.

The term “wireless node” or “network station” or “node,” or the like, may include, for example, a wireless station, such as a mobile station or subscriber station, an access point (AP) or base station, a relay station, a wireless personal digital assistant (PDA), a cell phone, an 802.11 WLAN phone, a WiMedia device, a WiMAX device, a wireless mesh point, or any other wireless device. These are merely a few examples of the wireless devices and technologies that may be used to implement the various example embodiments described herein, and this disclosure is not limited thereto.

According to an example embodiment, a large set of wireless signatures (e.g., modulated signals) may be generated for an orthogonal frequency division multiplexing (OFDM) system that may have good distance properties (e.g., the signals are easily separable, or may have a predetermined threshold of separability). The set of wireless signatures may be used, for example, to uniquely identify the presence or absence of a transmitter in a certain coverage area of a cellular type system. According to one example, a wireless signature identifier may be assigned to a mobile relay station (RS), such that a unique wireless signature may be generated based on the wireless signature identifier, that allows other entities in a communication system to detect the presence/absence of the mobile RS in a given coverage area. According to an example embodiment, non-coherent modulation techniques may be used, which may advantageously employ a simple detector. One skilled in the art will appreciate that the example techniques discussed herein may be adapted for use in a time division system using pulse position modulation, and other systems.

Example techniques for signal generation may be found in J. F. Pieper, et al., “Design of efficient coding and modulation for Rayleigh fading channel,” IEEE Information Theory, vol. 24, no. 4, pp. 457-468, July 1978. However, the example techniques discussed by Pieper et al. do not include generating signals for multiple access schemes. Conventional detection techniques for OFDM systems include WiFi carrier sensing; however carrier sensing techniques provide information that a channel may be occupied by a user, and may not provide information for identifying the user.

According to an example embodiment, as discussed below, wireless signatures may be generated that have very good separation, i.e. they can be easily identified. According to an example embodiment, the wireless signature of a transmitter may mark the presence/absence of the transmitter in a given coverage area. Based on good separability of the wireless signatures transmitted by different transmitters, it is possible to advantageously precisely identify transmitters that are operating within a coverage area. Thus, it is possible to determine not only that there is a transmitter in a coverage area (e.g., similarly to carrier sensing in WiFi), but further to determine identities of those transmitters that may overlap in the coverage area.

FIG. 3c is a block diagram illustrating a wireless network 302 according to an example embodiment. Similar to FIG. 3a as discussed previously, wireless network 302 may include a cellular type of system (e.g., WiMAX, 3.9G) with a base transceiver station (BTS) such as the base station BS1 304, and two fixed relay stations (RS), such as relay stations RS1 320 and RS2 330, attached to BS1 304. In the example of FIG. 3c, an example terminal TRM 340 may be allowed to roam within the cellular system. If the example terminal TRM 340 is RS capable (i.e., is configurable to operate as a relay station) and enters the coverage area of BS1 304, the example terminal TRM 340 may exchange information with BS1 304 and inform BS1 304 of the capabilities of the example terminal TRM 340.

Once the BS1 304 receives the information indicating that TRM 340 is RS capable, the BS1 304 may determine whether to enable the RS capabilities of the example terminal TRM 340. If BS1 304 enables TRM 340 to operate as a RS, the new RS may interfere with the operation of already deployed RS1 320 and RS2 330 if the new terminal TRM 340 is close to one or both of RS1 320 and RS2 330. However, if the terminal TRM 340 is not located in any coverage areas of RS1 320 and RS2 330, some system performance improvement may be lost if BS1 304 does not enable TRM 340 to operate as an RS. According to an example embodiment, the potential RS (e.g., TRM 340) may determine its location status regarding whether it is located in an interference area of RS1 320 or RS2 330, and may inform the BS1 304 of the determined location status. The BS1 304 may then determine whether to enable TRM 340 to operate as a RS based, for example, on the location status information provided by TRM 340.

According to an example embodiment, an example location status for a potential RS may be determined, and an enablement decision may be determined as follows:

1) The BTS, for example, BS1 304 may assign unique wireless signature identifiers to the already enabled relay stations, for example, RS1 320 and RS2 330, and the relay stations may generate and transmit their unique signatures based on the wireless signature identifiers;

2) The BTS, for example, BS1 304 may request the already enabled relay stations, for example, RS1 320 and RS2 330, to transmit their respective unique wireless signatures at predetermined time instants (e.g., at the same time instant), and may request the potential RS, for example, TRM 340, to detect the presence or absence of the wireless signatures;

3) The potential RS, for example, TRM 340 may enter detection mode at the time instants provided by the BTS (e.g., BS1 304) and may determine which wireless signatures can be detected;

4) One or more indicators of wireless signatures detected by the potential RS may be sent to the BTS, for example, BS1 304, which may then determine whether to enable the potential RS (e.g., TRM 340), and which may send its enablement decision at least to the potential RS (e.g., TRM 340).

According to an example embodiment, the wireless signatures discussed above may advantageously benefit (e.g., for detection by a potential RS) from satisfaction of one or more of the following conditions:

1) The wireless signatures may have a large minimum distance to ensure good separability;

2) There may exist a large pool of wireless signatures from which to choose, so that, for example, different sets of wireless signatures may be assigned to different BTSs in the network,

3) The wireless signatures may be easily generated and detected.

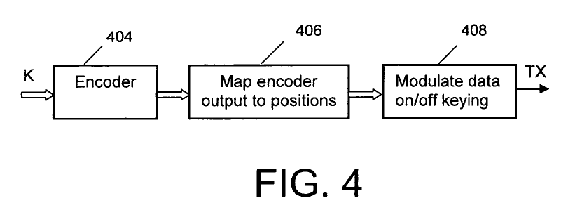

FIG. 4 is a block diagram illustrating an example system for generating a wireless signature. As shown in FIG. 4, an encoder 404 may receive as input K symbols, for example, the wireless signature identifier, which may uniquely identify the wireless signature to be generated. An output of the encoder may then be mapped into positions (406), wherein the positions may, for example, represent tones in an OFDM system. For example, in accordance with on/off keying modulation, energy may be transmitted for positions that are marked with nonzero values, while no energy may be transmitted for positions marked with zeroes (408). For example, the encoding may be performed at a relay station such as RS1 320 or RS2 330 based on wireless signature identifiers to generate and transmit unique wireless signatures. According to an example embodiment, the example on/off keying modulation technique discussed above may be used so that non-coherent detection (i.e., a simple detection technique) may be performed at the receiver.

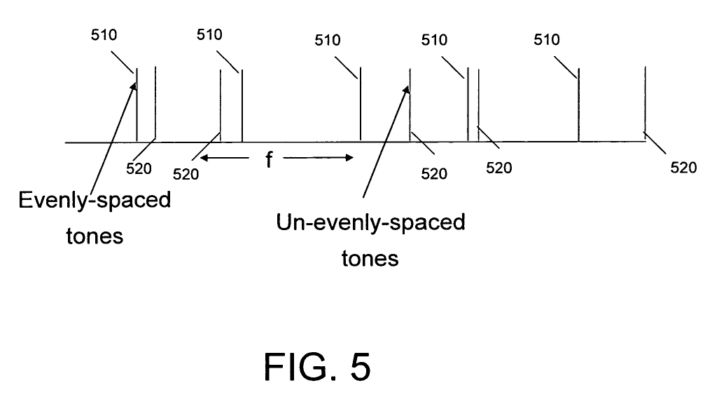

FIG. 5 illustrates an example frequency axis having evenly-spaced tones 510 and unevenly-spaced tones 520. Thus, a receiver may know when it should receive, or hear, the evenly-spaced tones 510, and may then easily determine and differentiate the unevenly-spaced tones 520 as being “dithered” around the evenly-spaced tones 510.

According to an example embodiment, wireless signatures may be generated based on non-binary codes having good distance properties. For example, an (N, K) non-binary code of length N may encode K symbols. Each symbol may be an element of an M-level alphabet whose levels are normalized to the set {0, 1, . . . , M−1}. At least a number N*M of OFDM tones may be needed to convey the wireless signature. Thus, the wireless signature may be conveyed by transmitting energy on N tones out of N*M tones available for a wireless signature. An example technique for generating the positions for transmission of the tones may include:

1) A wireless signature may be identified based on a given K-tuple X=[x₁, . . . , X_{K}], which may be indicated as a wireless signature identifier, which may be used to generate one codeword Y=[y₁, . . . , y_{N}];

2) A fixed set having a cardinality N, of equally spaced numbers may be generated as Z={zᵢ|zᵢ=(i−1)M+1, i=1, . . . , N};

3) The wireless signature may be generated by transmitting energy on the tones determined by the positions S=Y+Z={sᵢ|sᵢ=zᵢ+yᵢ, i=1, . . . , N}, and by otherwise transmitting no energy on other tones out of the N*M total tones (i.e., on tones determined by positions other than the positions S=Y+Z). Referring to FIG. 5, an example set Z may be represented as the evenly-spaced tones 510, and an example of positions S may be represented by the tones 520.

The waveform type discussed above may be referred to as multitone M-level on/off keying (MTM-OOK), as the waveform uses N tones for transmitting energy (on), while the rest of the tones (i.e., N*M−N) transmit no energy (off) and the wireless signatures may be distinguished based on the M-level code offset relative to the fixed positions given by Z.

According to an example embodiment, Reed-Solomon codes may be used as example non-binary codes, as Reed-Solomon codes may have guaranteed minimum distance properties, may be very easy to generate, and may provide a large number of codewords. For example, an (N, K) Reed-Solomon code may include a minimum distance of N−K+1 between any two codewords, and may provide a number of M^{K}=(N+1)^{K} available codewords. Thus, for example, a Reed-Solomon (6, 2) code may have dₘᵢₙ=5. Further, if any two wireless signatures are received simultaneously, the maximum number of tones that may collide (i.e., overlap) is K−1, in the context of MTM-OOK.

An example detection technique for such example wireless signatures may be very simple. An example receiver may be provided with an indication of the positions of the tones where the energy is transmitted for each of one or more wireless signatures. Upon receipt of the wireless signatures that are used by transmitters, the receiver may simply determine a presence or absence of transmitted energy at the indicated tones in order to determine whether a particular wireless signature is received or not.

For example, a Reed-Solomon code may be used having length N=6 and K=2, and therefore M=7 levels. For example, S. B. Wicker, Error control system for digital communication and storage, Prentice Hall, 1995, on p. 188 includes a discussion of such non-standard Reed-Solomon code types. A total of M^{K}=7²=49 codewords may thus be generated, and thus, M^{K}=7²=49 wireless signatures may be generated. An example generator matrix may be determined as G=[16 3 2 4 0; 0 1 6 3 2 4].

Referring to the example of FIG. 3c, if the BS1 304 assigns an example wireless signature X1=[1 2] for RS1 320 and a wireless signature X2=[1 3] for RS2 330, then the corresponding codewords may be determined as Y1=[1 1 1 1 1 1] and Y2=[1 2 0 4 3 5], respectively. The set of fixed position that are equally spaced may be determined as Z=[1 8 15 22 29 36]. As discussed previously, N*M=6*7=42 available tones may be needed to generate the wireless signatures. The corresponding example wireless signatures for RS1 320 and RS2 330 may be transmitted by transmitting energy on the tones given by the example sets S1=[2 9 16 23 30 37] and S2=[2 10 15 26 32 41], respectively, and by transmitting no energy in all other tone positions out of the available 42 tone positions.

For the example discussed above, it is noted that there is one tone, 2, where the two wireless signatures collide, whereas all other five tones in the example wireless signatures S1 and S2 are distinct where the energy is present. Therefore, a receiver such as a potential RS, for example, TRM 340, may easily distinguish which wireless signatures are detected. According to an example embodiment, a receiver such as a potential RS may detect the wireless signatures by adding the received energy of the tones where RS1 320 and RS2 320 transmit energy (i.e. S1 and S2, respectively) and compare the values with a predetermined threshold. Thus, if the threshold is exceeded, then the corresponding wireless signature has been detected, and the potential RS is then presumed to be located in the coverage area of the corresponding RSs.

According to another example embodiment, a multitone on/off keying (MTOOK) signal, similar to techniques discussed by Pieper et al. for transmitting only single information elements, may be used to generate different wireless signatures. The example non-binary codes discussed previously have as output a multilevel codeword. For the example Reed-Solomon code discussed previously, the number of levels M is N+1, which may be large for large values of N. According to an example embodiment, for large N, M levels may be represented with a number of ceil(log₂(M)) bits. However, with only ceil(log₂(M)) bits, a large number of collisions may result. For example, if M=7 (e.g., as in the MTM-OOK examples discussed previously), 3 bits may be used to encode the M levels of the Reed-Solomon code (6, 2). For example, level 1 may be encoded by 001, while 5 may be encoded as 101, and these may be the last values in the codewords Y1 and Y2.

One skilled in the art of communications will appreciate, for example, that a bit string 001 may completely collide with 101 if energy is transmitted on a tone where a bit of 1 is present and no energy is transmitted where a bit of zero is present. Such a collision results when a receiver has no means to determine whether a bit string 101 received by the receiver is a result of superposition of the bit strings 100 and 001, or superposition of bit strings 101 and 000, or superposition of bit strings 101 and 100, or superposition of bit strings 101 and 001. Pieper et al. suggest limiting such an ambiguity by encoding the M levels with a more robust constant weight code that has m*ceil(log₂(M))<M bits. The total number of tones required for this type of signal is m*ceil(log₂(M))*N tones, and thus the number of tones needed for transmission may be reduced for large values of M. Furthermore, Hadamard rows may be used for mapping M level signals. In other words, each value in a Y codeword may be mapped into some binary values using a particular Hadamard code (which may be considered as inner code), and the energy may be transmitted if the tone position is nonzero.

According to an example embodiment, MTOOK signals may thus be used to generate distinct wireless signatures with good distance properties, in order to uniquely identify different entities, for example, such as transmitters.

One skilled in the art of communications will appreciate, for example, that if the total number of tones available for transmission are grouped in disjoint sets, the techniques discussed herein may also be applied for individual groups, separately or taken together.

According to another example embodiment, wireless signatures may be generated based on certain aspects of Reed-Solomon codes with respect to grouping the codewords in sets for which the constituent codewords in the sets have no collisions. Such groupings may provide advantageous features in assigning wireless signature identifiers to base/relay stations, as discussed previously.

As discussed previously, an example K-tuple wireless signature identifier of type X=[x₁, . . . , x_{K}] may be used to generate codewords Y=[y₁, . . . , y_{N}] for a multilevel (N+1 levels) Reed-Solomon code (N, K). As discussed by Wicker at p. 60, there exists a K-tuple Xₒₙₑₛ such that its codeword is all ones, i.e. Yₒₙₑₛ=[1, . . . , 1].

As Reed-Solomon codes are cyclic codes, the sum of any two codewords is also a codeword. Using this property, codewords having no collisions may be generated. For example, given an initial K-tuple X₁, then the subset S_{nocollision}={Yₚ|Yₚ codeword of Xₚ=Xₚ₋₁+Xₒₙₑₛ mod N+1, p=1, . . . , N+1 and X₁ given} is a set of N+1 codewords. Such codewords may be obtained recursively using Xₒₙₑₛ and the given X₁, as shown. Thus, there exist a total of M^{K-1}=(N+1)^{K-1} sets of codewords having no collisions.

TABLE 1
Example generation of a set having no collisions,
the set based on example (6, 2) Reed-Solomon code

| X index | [x₁ x₂] (modulo 7) | Y index | Y index (modulo 7) |
|---|---|---|---|
| Xₒₙₑₛ | [1 2] | | [1 1 1 1 1 1] |
| X₁ (initial) | [0 3] | Y₁ | [0 3 4 2 6 5] |
| X₂ | [1 5] | Y₂ | [1 4 5 3 0 6] |
| X₃ | [2 0] | Y₃ | [2 5 6 4 1 0] |
| X₄ | [3 2] | Y₄ | [3 6 0 5 2 1] |
| X₅ | [4 4] | Y₅ | [4 0 1 6 3 2] |
| X₆ | [5 6] | Y₆ | [5 1 2 0 4 3] |
| X₇ | [6 1] | Y₇ | [6 2 3 1 5 4] |

The example subset {Y₁, . . . , Y₇} of codewords shown in Table 1, generated based on {X₁, . . . , X₇}, has no collisions. The codewords may be generated, for example, using the (6, 2) Reed-Solomon code which has been discussed previously. All codewords from the above subset have no pairwise collisions. Moreover, when all of the codewords shown above are used simultaneously there are still no collisions; thus, a receiver may be able to distinguish each of them precisely, assuming there is no noise. Referring to the example of FIG. 3c, if such a set is used within a cell/sector to assign different wireless signatures or wireless signature identifiers to different RSs (e.g., RS1 320 and RS2 330), then the wireless signatures may exhibit no collisions if observed.

It is noted that for such an example (6, 2) Reed-Solomon code there may exist M^{K-1}=7 such possible sets that may be used to generate wireless signatures having no collisions. However, in assignment of wireless signatures, it may be considered that codewords from any two different subsets may collide, and such collisions may be considered in order to minimize the potential collisions if two subsets are used adjacently, for example, for adjacent cells. Thus, partitioning the pool of wireless signatures available into subsets that have no collisions may provide advantageous planning for wireless signature assignments to different entities that need to be identified easily in the system.

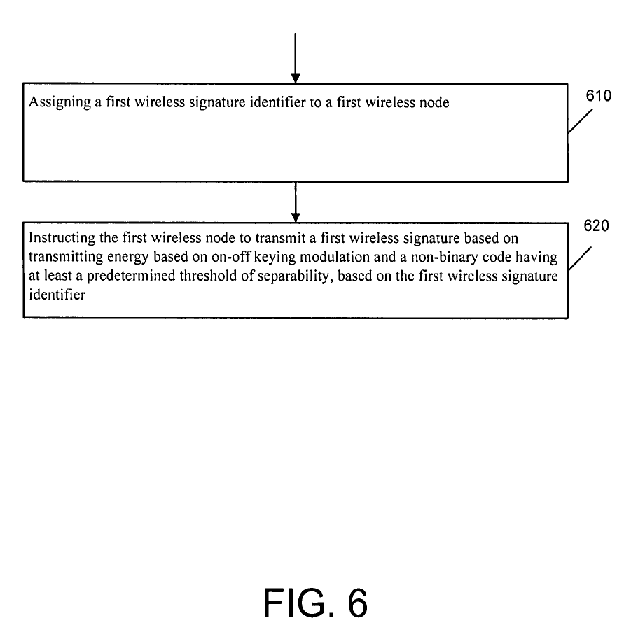

FIG. 6 is a flow chart illustrating operation at a wireless node according to an example embodiment. At 610, a first wireless signature identifier may be assigned to a first wireless node. For example, the first wireless signature identifier may be assigned to the RS1 320. For example, the BS1 340 may assign the first wireless signature to the RS1 320. At 620, the first wireless node may be instructed to transmit the first wireless signature. For example, the RS1 320 may be instructed to transmit a first wireless signature based on transmitting energy based on on-off keying modulation and a non-binary code having at least a predetermined threshold of separability, based on the first wireless signature identifier. According to an example embodiment, the first wireless signature may be generated based on an (N, K) Reed-Solomon code, as discussed previously. For example, the BS1 340 may send the first wireless signature identifier, for example, an indication of K symbols to the RS1 320. The RS1 320 may then input the K symbols to an encoder, for example, the encoder 404 of FIG. 4 as discussed previously. The RS1 320 may then generate and transmit the first wireless signature.

According to another example embodiment, the first wireless signature may be generated based on a multitone M-level on-off keying (MTM-OOK) type of waveform. According to another example embodiment, the first wireless signature may be generated based on a multitone on-off keying (MTOOK) type of waveform as discussed previously.

According to yet another example embodiment, the first wireless signature may be generated based on a multitone on-off keying (MTOOK) type of waveform based on a Hadamard code as discussed previously. According to yet another example embodiment, the first wireless signature may be generated based on a multi-level (N, K) Reed-Solomon code, wherein a set of codewords having no collisions is generated based on a codeword represented as an N-tuple having a value of 1 in each position of the N-tuple.

According to an example embodiment, a second wireless node identifier may be assigned to a second wireless node, and the second wireless node may be instructed to transmit a second wireless signature based on transmitting energy based on on-off keying modulation and the non-binary code, based on the second wireless signature identifier. For example, the RS2 330 may be assigned the second wireless signature identifier, and may be instructed to transmit the second wireless signature.

According to an example embodiment, an indicator of the first wireless signature may be sent to a third wireless node. For example, the indicator of the first wireless signature, for example, an indicator of a range of the first wireless signature may be sent to the TRM 340. An indication of whether the third wireless node is receiving the first wireless signature from the first wireless node may be received from the third wireless node. For example, the BS1 304 may receive an indication of whether the TRM 340 is receiving the first wireless signature from the first wireless node. It may then be determined whether to enable the third wireless node as a relay station, For example, the BS1 304 may then make a determination whether to enable the TRM 340 as a relay station, for example, based on whether the enablement may enhance the coverage area.

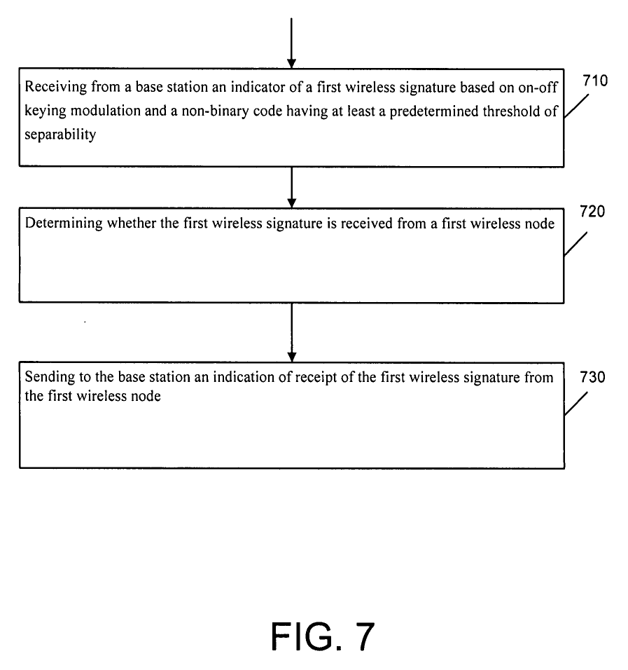

FIG. 7 is a flow chart illustrating operation at a wireless node according to another example embodiment. At 710, an indicator of a first wireless signature based on on-off keying modulation and a non-binary code having at least a predetermined threshold of separability may be received from a base station. For example, the TRM 340 may receive the indicator of the first wireless signatures from the BS1 304. For example, the indicator may include an example range associated with the first wireless signature.

At 720, it may be determined whether the first wireless signature is received from a first wireless node. For example, the TRM 340 may determine whether the first wireless signature is received from the RS1 320, for example, by decoding a received transmission.

At 730, an indication of receipt of the first wireless signature from the first wireless node may be sent to the base station. For example, the TRM 340 may send an indication of receipt of the first wireless signature to the BS1 304. The BS1 304, for example, may then make a decision whether to enable the TRM 340 as a relay station.

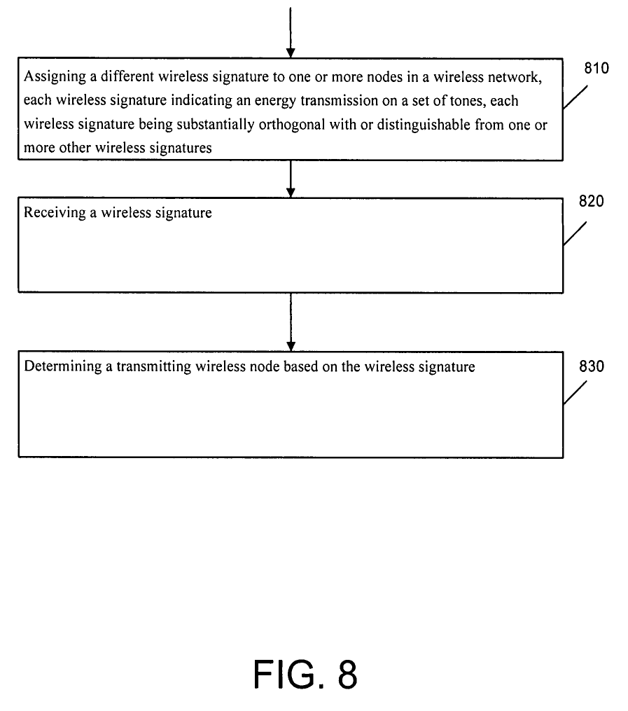

FIG. 8 is a flow chart illustrating operation at a wireless node according to another example embodiment. At 810, a different wireless signature may be assigned to one or more nodes in a wireless network, each wireless signature indicating an energy transmission on a set of tones, each wireless signature being substantially orthogonal with or distinguishable from one or more other wireless signatures. For example, the BS1 340 may assign different wireless signatures to the RS1 320 and RS2 330 as discussed previously.

At 820, a wireless signature may be received. For example, the TRM 340 or the BS1 340 may receive the wireless signature, for example, from the RS1 320.

At 830, a transmitting wireless node may be determined based on the wireless signature. For example, the TRM 340 or the BS1 340 may determine that the wireless signature is received from the RS1 320. For example, the determination may be made by decoding a received transmission.

As previously discussed, example techniques may be provided for generating a set of wireless signatures for an example OFDM system. The wireless signatures may possess good separability properties, which may aid the process of correctly identifying them when a small subset of wireless signatures is used simultaneously. For example, to uniquely identify the relay stations in a wireless network, a unique wireless signature identifier may be assigned to a RS so that the RS may generate and transmit a unique wireless signature based on the wireless signature identifier. In a given coverage area there is usually a small number of RSs that are present. Taking into account the good separability of the wireless signatures it is easy to identify each RS that operates in that area. It may be noted that the set of wireless signatures that are used may be relatively small, because the number of collisions increases with each additional wireless signature added to the subset. However, particular to each code, subsets of wireless signatures may be determined such that the wireless signatures have no collisions within the subset.

As discussed previously, signaling techniques using MTM-OOK and MTOOK modulations may map a codeword of a wireless signature into positions of tones that either transmit energy or do not transmit energy, with constant energy required for each wireless signature, i.e., the codewords have constant weight. Such a simple example generation technique may ensure an easy detection of presence of signal at a receiver. It is noted that the method of generating the wireless signatures uses only non-coherent detection, and does not require coherent detection, which may be expensive.

The example techniques discussed above may thus use example Reed-Solomon codes to “dither” OFDM tones with fixed-spacing, where spacing >1 tone for existing pilot-tone patterns, for example. The example techniques may also have minimal impact on peak to average power ratio (PAPR), for example, if conventional IEEE 802.16 pilots are used.

As discussed above, the example wireless signatures may be used as relay station wireless signatures, for example, for determining whether a terminal, for example, a mobile station (MS) will be designated as a relay station (RS) or will maintain its status as a MS. According to an example embodiment, the example wireless signatures may be based on an example Reed-Solomon (R-S) code that is non-radix 2 (e.g., GF(7), GF(41)). For example, a Reed-Solomon code may be used that is an (N, K)=(6, 2) code over GF(7), R-S code with GF(p^{m}), where p=7 is prime and m=1.

According to an example embodiment, a system may have a number of relay stations <p^{K}, for using N equally-spaced tones and (N*p) total tone locations.

The techniques discussed previously may provide non-overlapping codewords in sub-sets of wireless signature patterns using an “in-symbol” shifting operator, which may be provided in the code-space of an example Reed-Solomon (e.g., a symbol including only a value of 1 in all positions).

By using the example techniques discussed previously a random search for wireless signatures may be performed over the entire space, or p^{K} codewords, where the vector space for an example RS is p^{K} codewords (i.e., no random search over wireless signature subsets is needed).

The example techniques discussed above may also be used in other types of systems, for example, with pulse position modulation, for a time division system.

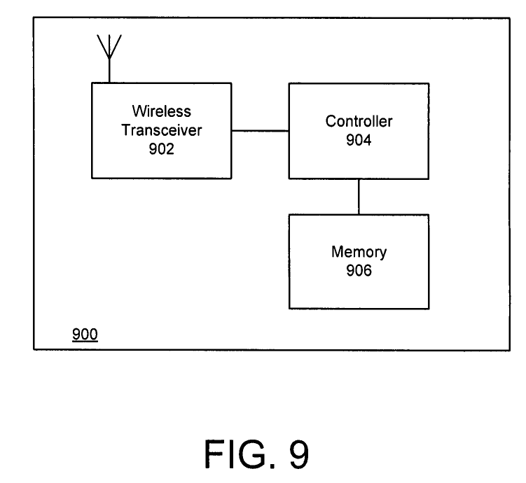

FIG. 9 is a block diagram illustrating an apparatus 900 that may be provided in a wireless node according to an example embodiment. The wireless node (e.g. station or AP) may include, for example, a wireless transceiver 902 to transmit and receive signals, a controller 904 to control operation of the station and execute instructions or software, and a memory 906 to store data and/or instructions.

Controller 904 may be programmable and capable of executing software or other instructions stored in memory or on other computer media to perform the various tasks and functions described above, such as one or more of the tasks or methods described above in FIGS. 1-8.

In addition, a storage medium may be provided that includes stored instructions, when executed by a controller or processor that may result in the controller 904, or other controller or processor, performing one or more of the functions or tasks described above.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

While certain features of the described implementations have been illustrated as described herein, many modifications, substitutions, changes and equivalents will now occur to those skilled in the art.

1. A method of identifying wireless nodes in a relay network, the method comprising:
assigning a first wireless signature identifier to a first wireless node; and
instructing the first wireless node to transmit a first wireless signature based on transmitting energy based on on-off keying modulation and a non-binary code having at least a predetermined threshold of separability, based on the first wireless signature identifier.

2. The method of claim 1 and further comprising:
assigning a second wireless signature identifier to a second wireless node; and
instructing the second wireless node to transmit a second wireless signature based on transmitting energy based on on-off keying modulation and the non-binary code, based on the second wireless signature identifier.

3. The method of claim 1 and further comprising:
determining whether a third wireless node receives transmissions from the first wireless node based on the first wireless signature transmitted from the first wireless node.

4. The method of claim 1 wherein the first wireless signature is included in a set of wireless signatures generated for an orthogonal frequency division multiplexing (OFDM) system.

5. The method of claim 1 wherein the first wireless signature is included in a set of wireless signatures generated for a time division system based on pulse position modulation.

6. The method of claim 1 wherein the first wireless signature indicates that the first wireless node is instructed to transmit energy during an interval indicated by a binary value of 1, and to transmit no energy during an interval indicated by a binary value of 0 included in the first wireless signature.

7. The method of claim 1 wherein the first wireless signature is generated by the first wireless node based on an (N, K) Reed-Solomon code.

8. The method of claim 1 wherein the first wireless signature is generated by the first wireless node based on a multitone M-level on-off keying (MTM-OOK) type of waveform.

9. The method of claim 1 wherein the first wireless signature is generated by the first wireless node based on a multitone on-off keying (MTOOK) type of waveform.

10. The method of claim 1 wherein the first wireless signature is generated by the first wireless node based on a multitone on-off keying (MTOOK) type of waveform based on a Hadamard code.

11. The method of claim 1 wherein the first wireless signature is transmitted based on a multi-level (N, K) Reed-Solomon code, wherein a set of codewords having no collisions is generated based on a codeword represented as an N-tuple having a value of 1 in each position of the N-tuple.

12. The method of claim 1 wherein the first wireless signature is transmitted based a multi-level (N, K) Reed-Solomon code, wherein a set of codewords having no collisions is generated based on recursive generation of the codewords, based at least in part on a codeword represented as a N-tuple having a value of 1 in each position of the N-tuple.

13. The method of claim 1 and further comprising:
sending an indicator of the first wireless signature to a third wireless node,
receiving from the third wireless node an indication of whether the third wireless node is receiving the first wireless signature from the first wireless node; and
determining whether to enable the third wireless node as a relay station.

14. The method of claim 1 wherein the assigning the first wireless signature identifier comprises determining at a base station the first wireless signature identifier for generation of the first wireless signature based on on-off keying modulation and the non-binary code having at least the predetermined threshold of separability.

15. The method of claim 1 wherein the instructing the first wireless node to transmit the first wireless signature comprises instructing a first relay station to transmit the first wireless signature.

16. A method comprising:
receiving from a base station an indicator of a first wireless signature based on on-off keying modulation and a non-binary code having at least a predetermined threshold of separability;
determining whether the first wireless signature is received from a first wireless node; and
sending to the base station an indication of receipt of the first wireless signature from the first wireless node.

17. An apparatus for wireless communications, the apparatus comprising:
a controller;
a memory coupled to the controller; and
a wireless transceiver coupled to the controller;
the apparatus adapted to:
assign a first wireless signature identifier to a first wireless node; and
instruct the first wireless node to transmit a first wireless signature based on transmitting energy based on on-off keying modulation and a non-binary code having a predetermined threshold of separability, based on the first wireless signature identifier.

18. An apparatus for wireless communications, the apparatus comprising:
a controller;
a memory coupled to the controller; and
a wireless transceiver coupled to the controller;
the apparatus adapted to:
receive from a base station an indicator of a first wireless signature based on on-off keying modulation and a non-binary code having a predetermined threshold of separability;
determine whether the first wireless signature is received from a first wireless node; and
send to the base station an indication of receipt of the first wireless signature from the first wireless node.

19. A method comprising:
assigning a different wireless signature to one or more nodes in a wireless network, each wireless signature indicating an energy transmission on a set of tones, each wireless signature being substantially orthogonal with or distinguishable from one or more other wireless signatures;
receiving a wireless signature; and
determining a transmitting wireless node based on the wireless signature.

20. The method of claim 19 wherein the assigning comprises assigning a different wireless signature to one or more nodes in a wireless network, each wireless signature based on on-off keying modulation.

21. The method of claim 19 wherein the assigning comprises assigning a different wireless signature to one or more nodes in a wireless network, each wireless signature based on a multitone M-level on-off keying (MTM-OOK) type of waveform.

22. The method of claim 19 wherein the assigning comprises assigning a different wireless signature to one or more nodes in a wireless network, each wireless signature based on a multitone on-off keying (MTOOK) type of waveform based on a Hadamard code.

23. The method of claim 19 wherein the assigning comprises assigning a different wireless signature to one or more nodes in a wireless network, each wireless signature based on a multi-level Reed-Solomon code.

24. The method of claim 19 wherein the assigning comprises assigning a different wireless signature to one or more nodes in a wireless network, each wireless signature based on a multi-level (N, K) Reed-Solomon code, wherein a set of codewords having no collisions is generated based on a codeword represented as a N-tuple having a value of 1 in each position of the N-tuple.
